(19) United States
(12) Patent Application Publication
(10) Pub. No.: US 2017/0046803 A1
(43) Pub. Date: Feb. 16, 2017

(54) AUTOMATIC SPACE EXCHANGE OPPORTUNITY RESPONSE SYSTEMS AND METHODS

(71) Applicant: Yapta, Inc., Seattle, WA (US)

(72) Inventors: Jonathan WANG, Bellevue, WA (US); James FILSINGER, Bainbridge Island, WA (US); Valerie LAYMAN, Seattle, WA (US); Russell BARBER, Bellevue, WA (US); Chris BOUZEK, Bellevue, WA (US); Karim MEGHJI, Redmond, WA (US); Stephen MULLINS, Seattle, WA (US); Megan SCHNEIDER, Seattle, WA (US)

(21) Appl. No.: 15/333,114

(22) Filed: Oct. 24, 2016

Related U.S. Application Data
(63) Continuation-in-part of application No. 13/888,991, filed on May 7, 2013, now abandoned.
Application No. 13/888,991 is a continuation-in-part of application No. 13/918,665, filed on Jun. 14, 2013.
(60) Provisional application No. 61/643,850, filed on May 7, 2012.
(60) Provisional application No. 61/659,822, filed on Jun. 14, 2012.

(51) Int. Cl. G06Q 50/14; G06Q 10/02

(52) U.S. Cl. CPC G06Q 50/14; G06Q 10/025

(57) ABSTRACT

A passenger ticket, lodging, or other physical space availability may be monitored by obtaining an itinerary record or other dataset associated with a previous space allocation (a previously-booked itinerary or similar purchase, e.g.). This may include, for example, identifying a group of travel segments that corresponds to a ticket or other allocation, “fingerprinting” the allocation, and determining a schedule to periodically monitor terms associated with the allocation. During an availability-monitoring period, an up-to-date version of the itinerary record may be obtained and “fingerprinted,” for example, such fingerprints being usable to determine whether substitutions (identifying more preferable lodging or travel spaces, e.g.) have changed significantly or have already been discovered and implemented, and to take appropriate action (implementing a substitution or updating the itinerary record, e.g.) if so.

### FIELD

This disclosure is directed to computer-based physical space availability monitoring. More particularly, this disclosure is directed to post-purchase availability-monitoring for goods or services such as transportation or lodging spaces that are committed in advance and that may have significant fluctuations (promotions, e.g.) in the variety of spaces available or in the terms under which the spaces are available.

### BACKGROUND

Airlines, hotels, and other private businesses often structure their services in an attempt to maximize profitability. The terms and conditions of human-occupied spaces in the hospitality industry (airline tickets or hotel rooms, e.g.) have become increasingly complicated and are commonly determined by computerized yield management systems.

Many such businesses use differentiated schemes to simultaneously sell services with varying terms and conditions to different market segments. Factors influencing the space allocations frequently include the days remaining until the event (of lodging or travel, e.g.), the booked load factor, the forecast of total demand by product/service category, variations by day of week and/or by time of day, and the like.

In the airline industry, for example, travel classes are often represented by a “class code” or reservations/booking designator such as “F” and “P” for first class and first class premium, “C” and “J” for business and business premium, “Y” for economy/coach, and so on. With the advent of a competitive online market and more frequent travel, there may be dozens of available travel classes, with a corresponding number of class codes to differentiate between them.

Since the late 1970s, computerized reservation systems (“CRS”) have been used by airlines and travel agencies to store and retrieve information and coordinate services for travelers. Large CRS operations that book and sell tickets for multiple airlines are also known as global distribution systems (“GDS”). In addition to airline tickets, some modern computerized reservation systems also allow users to book other travel-related services, such as hotel rooms and rental cars. Examples of major computerized reservation systems include Sabre Global Distribution System, provided by Sabre Holdings Corporation of Southlake, Tex.; Amadeus CRS, provided by Amadeus IT Holding S.A. of Madrid, Spain; Worldspan and Apollo CRS, both provided by Travelport Limited of Atlanta, Ga.; and the like.

Airlines commonly use the Airline Tariff Publishing Company of Washington, D.C. to distribute airfares to Computer Reservation Systems across the world. Airlines typically distribute airfares at least once per day, frequently several times daily, or even hourly for some markets.

The pricing volatility and complexity in the airfare market can present challenges for travelers who wish to find the best deal or have the confidence to book early when purchasing air travel, challenges that are multiplied for businesses that purchase air travel in large quantities.

### BRIEF DESCRIPTION OF THE DRAWINGS

FIG. 1 illustrates a simplified availability-monitoring system in which a monitoring server, CRS Server, travel-agent device, and traveler/guest device are connected to a network.

FIG. 2 illustrates several components of an exemplary monitoring server.

FIG. 3 illustrates a simplified sequence of communications among availability-monitoring server, CRS Server, and travel-agent device in an exemplary availability-monitoring scenario, in some variants.

FIG. 4 illustrates a simplified conceptual model of a flight PNR, in some variants.

FIG. 5 illustrates a routine for importing a Flight PNR into an availability-monitoring system, such as may be performed by an availability-monitoring server in some variants.

FIG. 6 illustrates a subroutine for extracting one or more monitor records from a given Flight PNR (and associated metadata), such as may be performed by an availability-monitoring server in some variants.

FIG. 7 illustrates a routine for monitoring the availability of a given monitor record, such as may be performed by an availability-monitoring server in some variants.

FIG. 8 illustrates a subroutine for checking up-to-date availability for flight segment(s) represented in a monitor record, such as may be performed by an availability-monitoring server in some variants.

FIG. 9 illustrates a subroutine for identifying flight segment group in a given Flight PNR, such as may be performed by an availability-monitoring server in some variants.

FIG. 10 illustrates a subroutine for determining travel ticket attributes corresponding to a given travel segment group, such as may be performed by an availability-monitoring server.

FIG. 11 illustrates a physical context of stationary facilities each having a space suitable for occupation by a guest.

FIG. 12 illustrates a physical context of a portable facility each having many spaces suitable for occupation by travelers.

FIG. 13 illustrates an event-sequencing structure comprising special-purpose transistor-based circuitry.

FIG. 14 illustrates a method for responding to a policy change or discovery of a substitutable physical space, such as may be performed by an availability-monitoring server in some variants.

### DESCRIPTION

Papers filed with this application are part of the present specification. This application claims priority to whatever application(s) are listed in the Application Data Sheet filed herewith and incorporates the same herein by reference in their entirety. This application also claims priority to whatever document(s) are listed in the Information Disclosure Statement filed herewith and incorporates the same herein by reference to the extent not inconsistent herewith.

Many aspects of the detailed description that follows is expressed in terms of processes and symbolic representations of operations by computer components, including a processor, memory storage devices for the processor, connected display devices and input devices. Furthermore, some of these processes and operations may utilize conventional computer components in a heterogeneous distributed computing environment, including remote file servers, computer servers and memory storage devices. Unconventional computer components and processes are described herein with greater explicitness sufficient to enable one of ordinary skill to make and use embodiments as claimed without any undue experimentation.

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise.

“Above,” “according to,” “allocated,” “as,” “associated,” “at least,” “available,” “based,” “booked,” “both,” “compared,” “comprising,” “computerized,” “conditionally,” “determined,” “determined,” “determined by,” “each,” “exceeding,” “identified,” “included,” “inferior,” “inferior,” “initial,” “large enough,” “more of,” “occupied,” “of,” “partly,” “physical,” “purchased,” “real-time,” “re-booked,” “re-ticketed,” “substitute,” “suitable,” “superior,” “wherein,” “within,” or other such descriptors herein are used in their normal yes-or-no sense, not as terms of degree, unless context dictates otherwise. In light of the present disclosure those skilled in the art will understand from context what is meant by “remote” and by other such positional descriptors used herein. Terms like “processor,” “center,” “unit,” “computer,” or other such descriptors herein are used in their normal sense, in reference to an inanimate structure. Such terms do not include any people, irrespective of their location or employment or other association with the thing described, unless context dictates otherwise. “For” is not used to articulate a mere intended purpose in phrases like “circuitry for” or “instruction for,” moreover, but is used normally, in descriptively identifying special purpose software or structures.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

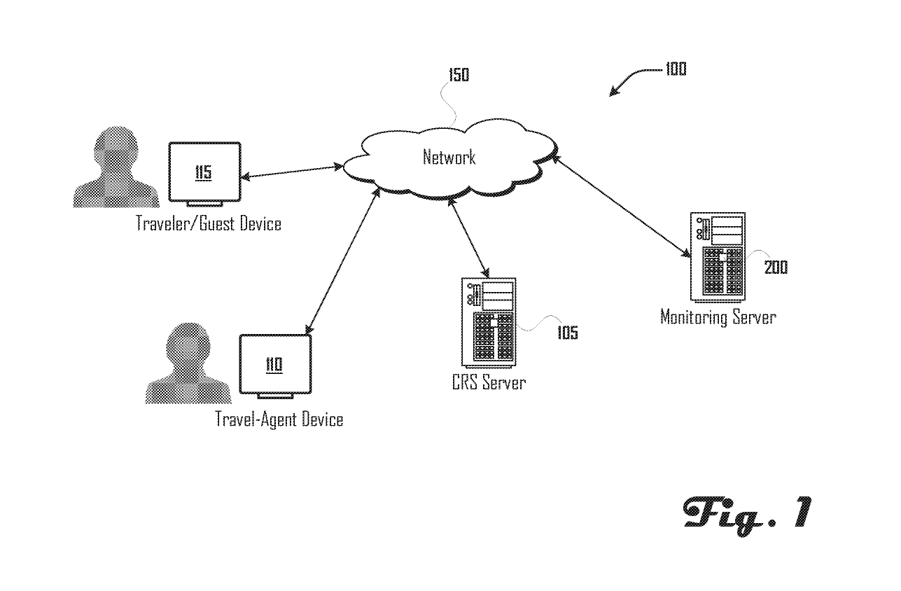

FIG. 1 illustrates a simplified space availability-monitoring system in which availability-monitoring server 200, CRS Server 105, travel-agent device 110, and traveler/guest device 115 are connected to network 150. In an exemplary scenario, an individual or entity that operates traveler/guest device 115 may engage the travel agency that operates travel-agent device 110 to purchase flights and/or other travel services via CRS Server 105. Either the traveler/guest, an entity associated with the traveler/guest (e.g., an employer), or the travel agency may engage an availability monitoring service that operates availability-monitoring server 200 to monitor post-purchase availability changes for favorable opportunities for substitutions. In some embodiments, availability-monitoring server 200 may also be operated by the travel agency.

In various embodiments, network 150 may include the Internet, a local area network (“LAN”), a wide area network (“WAN”), and/or other data network.

In various embodiments, additional infrastructure (e.g., cell sites, routers, gateways, firewalls, and the like), as well as additional devices (e.g., devices operated by airlines) may be present. Further, in some embodiments, the functions described as being provided by some or all of availability-monitoring server 200, CRS Server 105, travel-agent device 110, and/or traveler/guest device 115 may be implemented via various combinations of physical and/or logical devices. However, it is not necessary to show such infrastructure and implementation details in FIG. 1 in order to describe an illustrative embodiment.

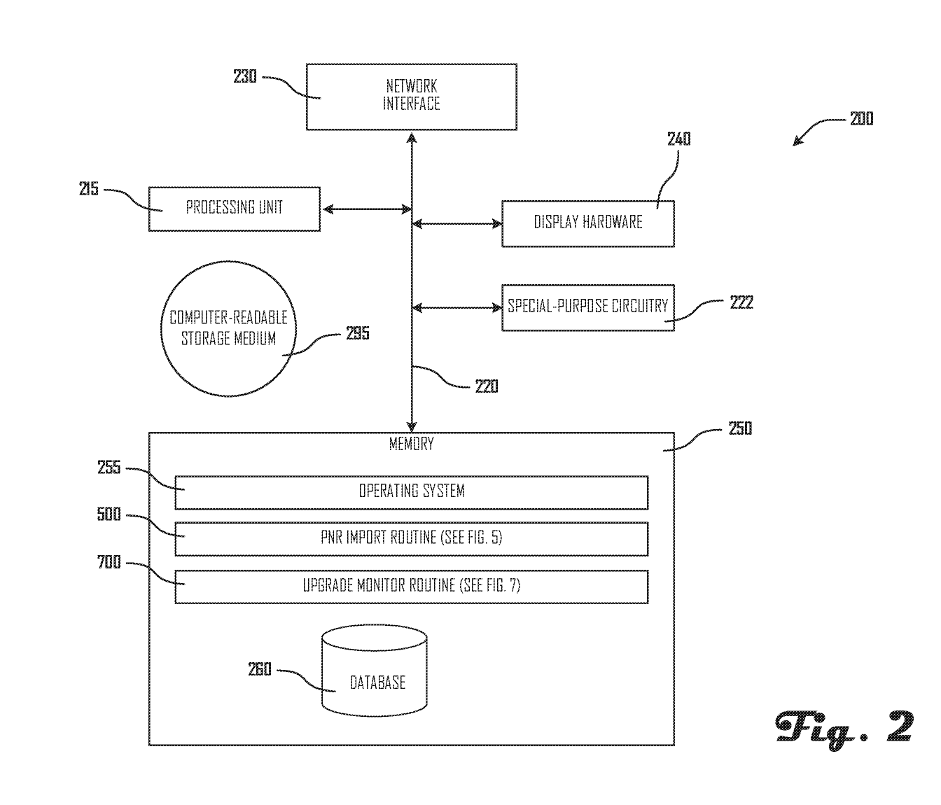

FIG. 2 illustrates several components of an exemplary availability-monitoring server 200. In some embodiments, availability-monitoring server 200 may include many more components than those shown in FIG. 2. However, it is not necessary that all of these components be shown in order to disclose an illustrative embodiment. As shown in FIG. 2, availability-monitoring server 200 includes a data network interface 230 for connecting to data network 150.

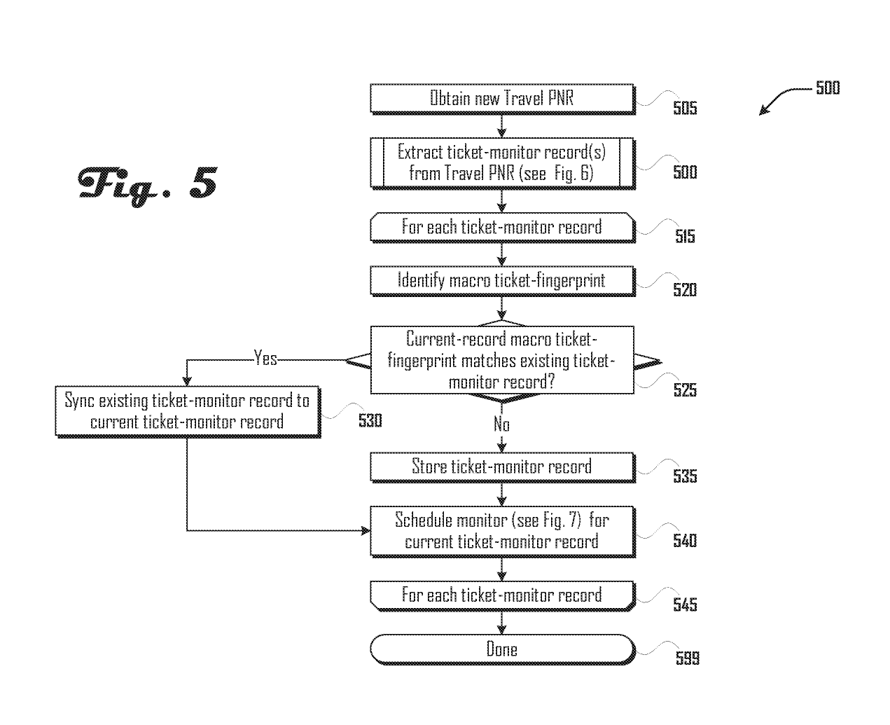

Availability-monitoring server 200 also includes a processing unit 215, a memory 250, special-purpose circuitry 222 as described below, and an optional display 240, all interconnected along with the network interface 230 via bus 220. The memory 250 generally comprises a random access memory (“RAM”), a read only memory (“ROM”), and a permanent mass storage device, such as a disk drive. The memory 250 stores program code for routine 500 for importing a Flight PNR into an availability-monitoring system (see FIG. 5) and routine 700 for monitoring the availability of a given monitor record (see FIG. 7).

In addition, the memory 250 also stores an operating system 255 and availability-monitor database 260 (or routines for access to an external database). These and other software components may be loaded from a non-transitory computer readable storage medium 295 into memory 250 of the availability-monitoring server 200 using a drive mechanism (not shown) associated with a non-transitory computer readable storage medium 295, such as a floppy disc, tape, DVD/CD-ROM drive, flash card, memory card, or the like. In some embodiments, software components may also be loaded via the network interface 230, rather than via a computer readable storage medium 295.

Although availability-monitoring server 200 has been depicted as a desktop computing device, in other embodiments, availability-monitoring server 200 may include other computing devices capable of communicating with data network 150, for example, a mobile phone, an tablet, a set-top box, or other like device.

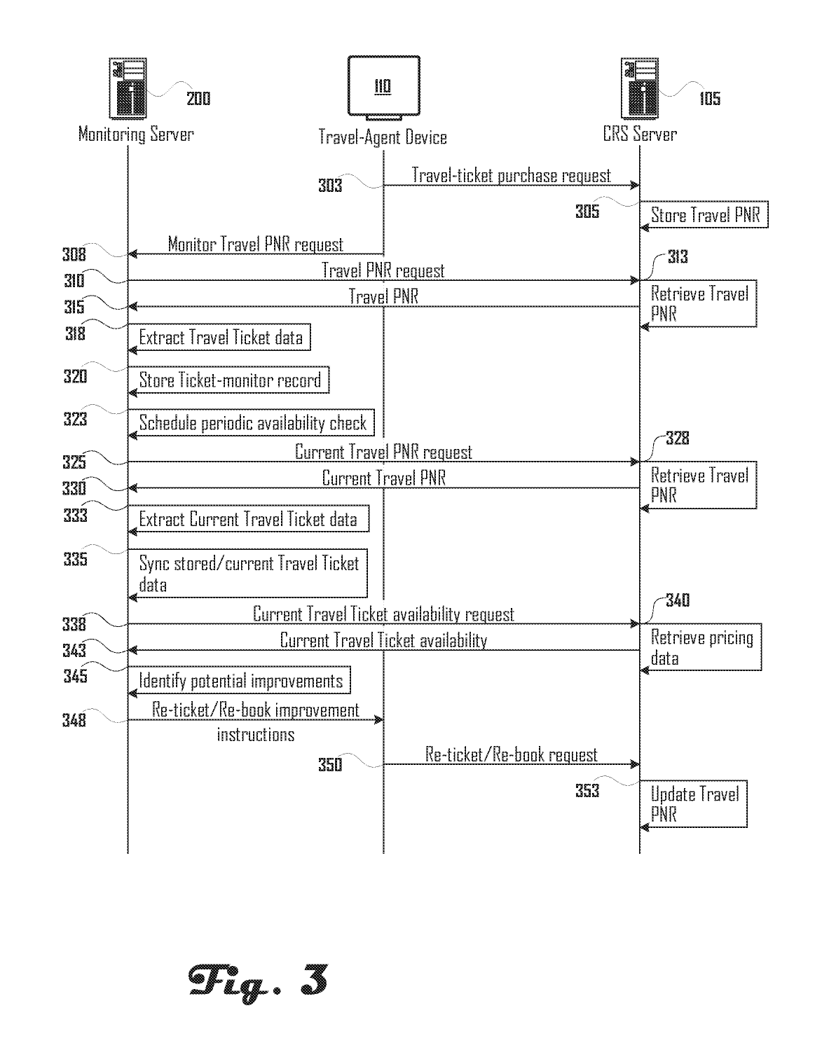

FIG. 3 illustrates a simplified sequence of communications among availability-monitoring server 200, CRS Server 105, and travel-agent device 110 in an exemplary availability-monitoring scenario, in some variants. Beginning the exemplary scenario, travel-agent device 110 sends to CRS Server 105 a request 303 to purchase a ticket for a given traveler/guest.

CRS Server 105 processes the request and stores a Passenger Name Record (“PNR”) 305 corresponding to the purchased flight. A PNR is a record stored in the database of a computer reservation system (CRS) that contains data related to an itinerary for a traveler or a group of travelers lodging or traveling together.

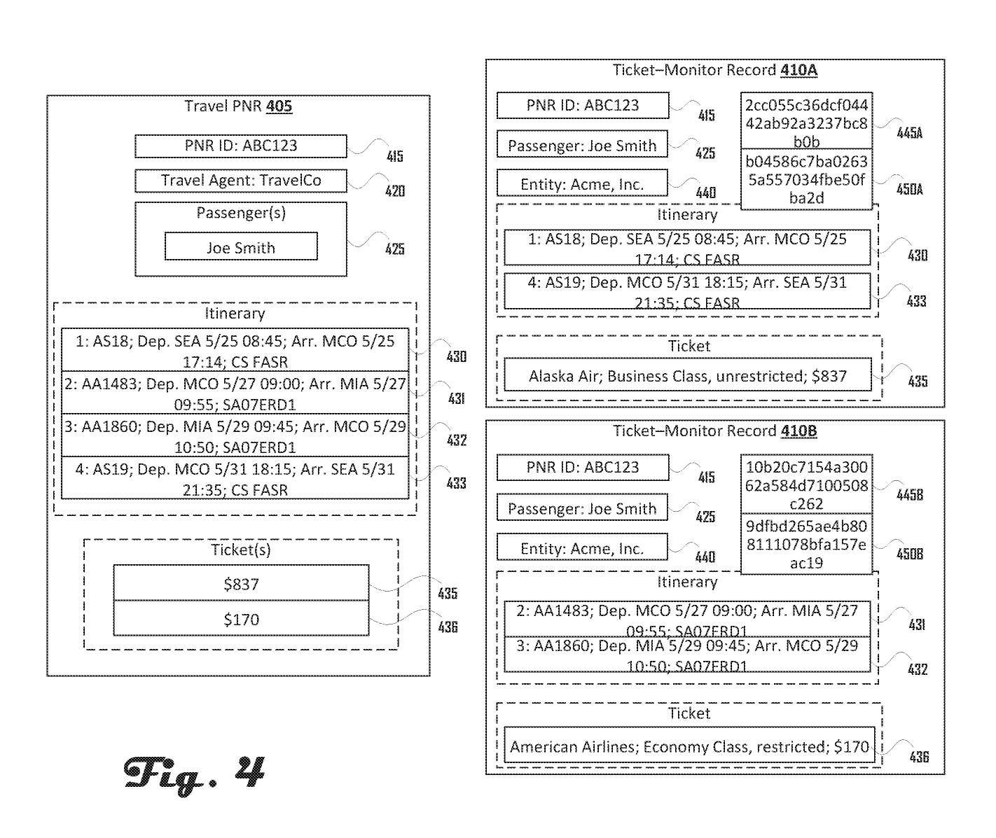

For example, FIG. 4 illustrates a simplified conceptual model of a flight PNR 405, in some variants. While each CRS system maintains its own standard for the content and structure of a PNR, in general, a PNR (e.g., PNR 405) includes at least the following information:
name(s) of the passenger(s) (e.g., name 425);
a booking-agent identifier and/or contact information, which may include a “pseudo city code” (“PCC”) associated with the booking agent (e.g., travel-agent identifier 420);
booking details (e.g., facility, space type, and the like) (e.g., ticket details 435-36); and
an itinerary for one or more flight segments (common to all passengers listed) (e.g., flight segments 430-33, including for each flight segment, a “fare basis code” specifying fare class and restrictions).

A PNR is also associated with an identifier (e.g., identifier 415), usually referred to as a “Record Locator”. Although PNR Record Locators are re-used after the listed itinerary has been completed, PNR Record Locators uniquely identify only one PNR at any given point in time. In practice, PNRs may also include many additional pieces of information, such as traveler/guest demographic data, special requirements, and free-form remarks.

Referring again to FIG. 3, having booked the flight (see request 303, discussed above), travel-agent device 110 communicates a request 308 to availability-monitoring server 200 to perform post-purchase availability monitoring for tickets corresponding to the newly created Flight PNR. In various embodiments, request 308 may be communicated via various channels, including via an application programming interface (“API”) provided by availability-monitoring server 200 or by placing the Flight PNR into a CRS queue, provided by CRS Server 105, the CRS queue being periodically monitored by availability-monitoring server 200 for PNRs queued by travel-agent device 110.

Either in response to request 308 or during periodic queue monitoring, availability-monitoring server 200 sends to CRS Server 105 a request 310 for Flight PNR 305. CRS Server 105 retrieves 313 the Flight PNR and sends the PNR 315 to availability-monitoring server 200.

Availability-monitoring server 200 extracts ticket data 318 for one or more tickets detailed in the Flight PNR and stores the extracted data to a monitor record 320.

For example, FIG. 4 also illustrates simplified conceptual models of a monitor records 410A-B extracted from flight PNR 405, in some variants. Monitor record 410A corresponds to ticket 435 and flight segments 430 and 433. Monitor record 410B corresponds to ticket 436 and flight segments 431-32. Monitor records 410A-B are discussed further below.

Referring again to FIG. 3, having stored at least one monitor record, availability-monitoring server 200 initiates a schedule 323 for price-checking the monitor record. In some embodiments, the availability-checking schedule may begin immediately (as one or more hours may have already passed since the ticket was booked).

Beginning the availability-checking process, availability-monitoring server 200 requests the Flight PNR in its current form from CRS Server 105. In some embodiments, it may be desirable to obtain the Flight PNR in its current form because the PNR could have been modified since availability-monitoring server 200 extracted the data for the monitor record. For example, the traveler/guest may have re-booked to a different flight, the airline may have changed the departure time or the flight number, the traveler/guest may have canceled the travel altogether, or some other entity may have initiated other like changes.

CRS Server 105 retrieves 328 the current Flight PNR and sends the PNR 330 to availability-monitoring server 200. Availability-monitoring server 200 extracts current ticket data 333 for the bookings detailed in the monitor record. If the current ticket data differs from the monitor record, availability-monitoring server 200 updates 335 the monitor record to reflect the currently extracted data.

Availability-monitoring server 200 then sends to CRS Server 105 a request 338 for current pricing data for the purchased ticket. CRS Server 105 retrieves 340 the current pricing data and sends the current pricing data 343 to availability-monitoring server 200. Availability-monitoring server 200 compares the purchase availability to the current pricing data to identify potential improvements 345, considering airline change fees (which may vary by airline, origin and destination of flights on the PNR, and fare rules of the ticket) and other transaction fees that may be imposed to re-book the flight.

If potential improvements are identified, availability-monitoring server 200 communicates re-book instructions 348 to travel-agent device 110. In various embodiments, instructions 348 may be communicated via various channels, including by inserting remarks into the Flight PNR and placing the Flight PNR into a CRS queue, provided by CRS Server 105, the CRS queue being periodically monitored by travel-agent device 110 for PNRs queued by availability-monitoring server 200. In some embodiments, availability-monitoring server 200 may select among two or more prioritized queues, depending on the urgency and/or importance of the identified potential improvements. In other embodiments, availability-monitoring server 200 may encode an “urgency” attribute into the Flight PNR before placing it into a CRS queue, such that travel-agent device 110 may be able to query the CRS queue according to “urgency” attributes to identify prioritized Flight PNRs.

Upon receiving the re-book instructions (and if a travel agent chooses to take advantage of the saving or other apparent improvement opportunity), travel-agent device 110 sends to CRS Server 105 a request 350 to re-book the flight. In response, CRS Server 105 updates 353 the Flight PNR to reflect the current re-booked flight data.

FIG. 5 illustrates a routine 500 for importing a Flight PNR into an availability-monitoring system, such as may be performed by availability-monitoring server 200 in some variants. In block 505, routine 500 obtains a new Flight PNR. Typically, the new Flight PNR describes an itinerary that was recently booked by a travel agent (identified in the Flight PNR), which made the Flight PNR available to routine 500. In one embodiment, the travel agent may make the Flight PNR available by placing it in a queue provided for this purpose by a computer reservation system and monitored by routine 500. Thus, in one embodiment, routine 500 may obtain the Flight PNR by requesting it from CRS Server 105.

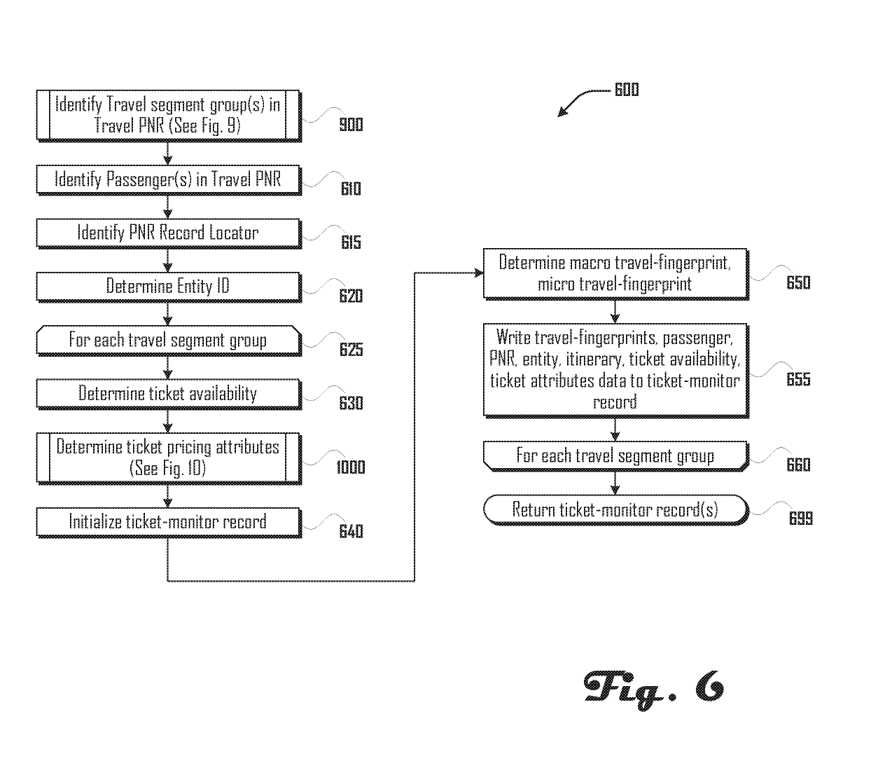

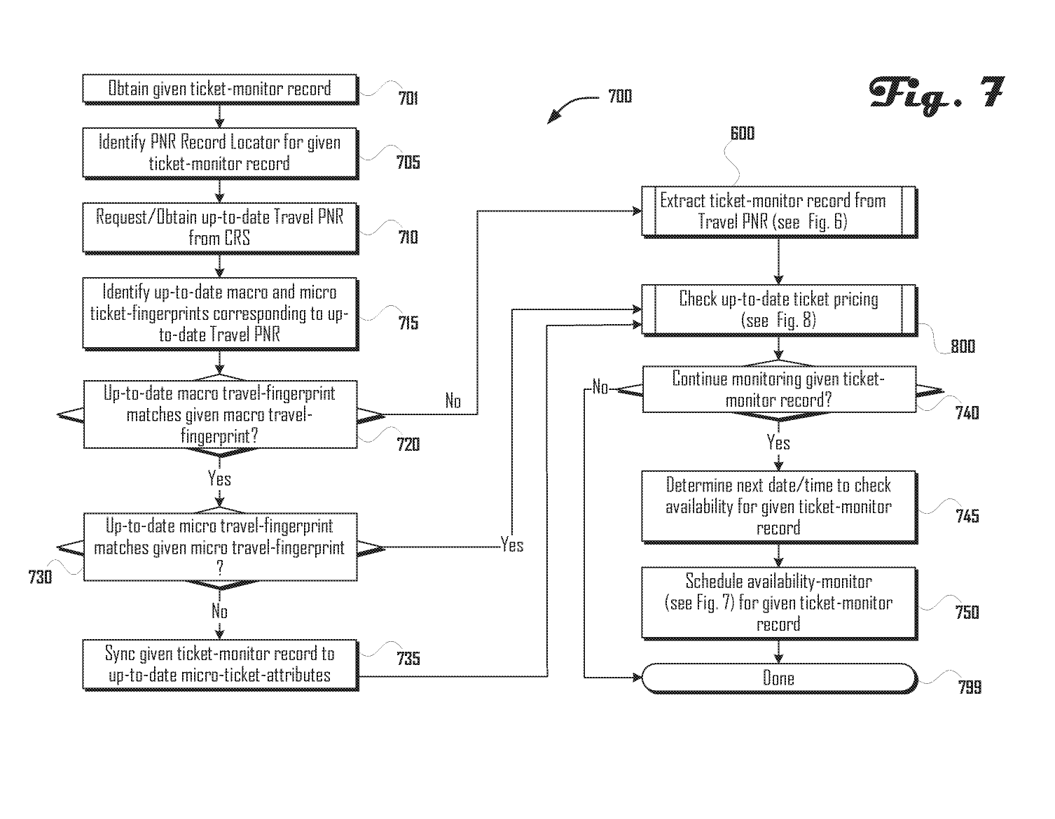

In subroutine block 600 (see FIG. 6, discussed below), routine 500 extracts one or more monitor records (see, e.g., records 410A-B) from the Flight PNR obtained in block 505. As discussed above, a Flight PNR can contain information for one or more travelers and one or more flight tickets, each ticket being associated with one or more flight segments. By contrast, a monitor record corresponds to exactly one flight ticket (which is associated with one or more flight segments). In one embodiment, a monitor record also corresponds to exactly one passenger (i.e., one flight ticket and one passenger), although in alternate embodiments, a monitor record could be adapted to include multiple passengers on the single flight ticket.

Beginning in opening loop block 515, routine 500 processes each of the one or more monitor records extracted from the Flight PNR. In block 520, routine 500 identifies a “macro” ticket-fingerprint comprising a set of attributes that identify the flight ticket in question. (See discussion of fingerprint attributes below in reference to blocks 650 and 655 of FIG. 6.) As mentioned above, PNRs can change for many reasons, and such a macro ticket-fingerprint may be useful to distinguish changes that are significant for availability-monitoring purposes (e.g., a change to a different airline, a different arrival and/or departure date, a different traveler/guest, a different origin and/or destination, and the like) from PNR changes that are less significant for availability-monitoring purposes (e.g., a change to a flight number, arrival and/or departure time, and the like). For example, in one embodiment, a macro ticket-fingerprint for monitor record 410A may indicate that passenger Smith of Acme, Inc. is traveling from Seattle to Orlando on Alaska Airlines on May 25. Or conversely, any PNR indicating that passenger Smith of Acme, Inc. is traveling from Seattle to Orlando on Alaska Airlines on May 25 should correspond to monitor record 410A, regardless of details that may be changed by the airline, such as flight number, arrival and/or departure times, and the like.

In some embodiments, the ticket attributes that make up a macro ticket-fingerprint of a monitor record may be encoded into a form that facilitates search, comparison, and/or storage efficiency, such as a message digest or “hash” computed using a cryptographic hash function, such as MD5, MD6, SHA-0, SHA-1 SHA-2, SHA-3, or the like. (See, e.g., fingerprint hashes 445A-B, 450A-B in records 410A-B.)

Using the macro ticket-fingerprint identified in block 520, routine 500 determines whether the monitor record currently being processed (extracted from the Flight PNR obtained in block 505) matches an existing monitor record in an availability-monitor database (e.g., database 260). Using monitor record 410A as an example, routine 500 queries an availability-monitor database to determine whether the availability-monitor system already has a monitor record corresponding to passenger Smith of Acme, Inc. traveling from Seattle to Orlando on Alaska Airlines on May 25. In one embodiment, this query may comprise determining whether a record in the database has a fingerprint hash that matches fingerprint hash 445A.

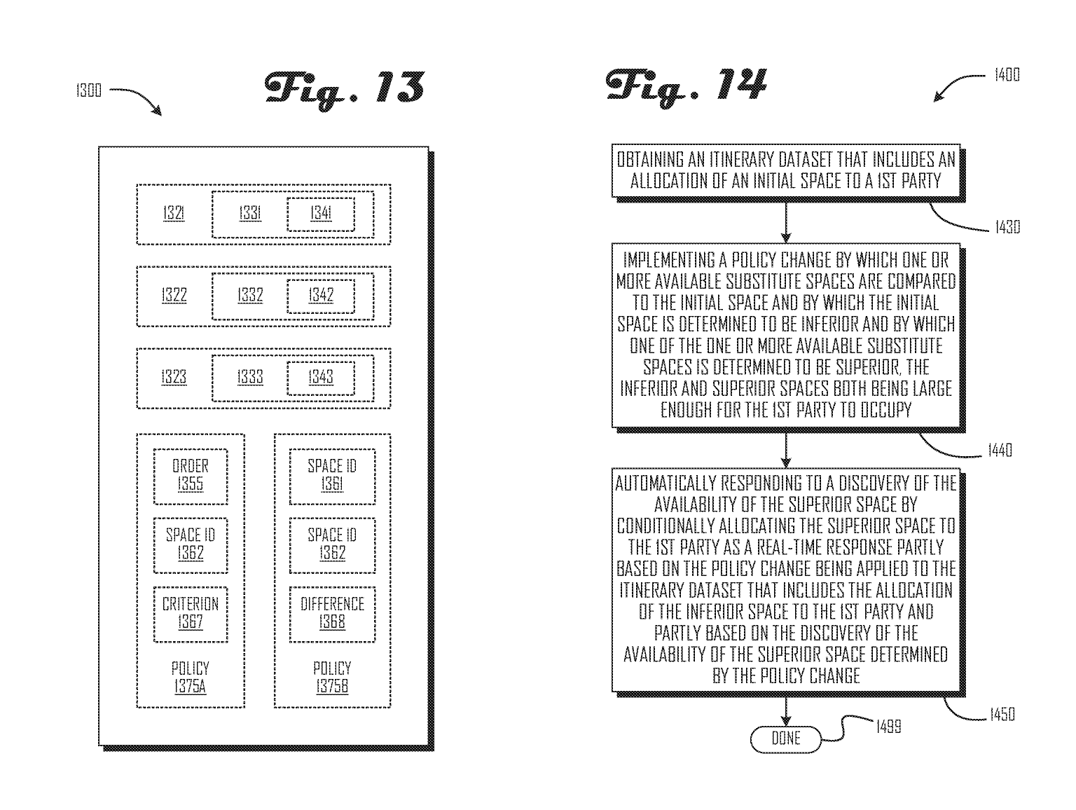

If in decision block 525, routine 500 determines that the monitor record currently being processed matches an existing monitor record stored in an availability-monitor database, then in block 530, routine 500 updates the existing monitor record so that its flight details (e.g., flight numbers, departure and/or arrival times, and the like) and purchase details match the data extracted from the Flight PNR obtained in block 505. Additionally, if the Flight PNR had been re-ticketed or re-booked as a result of a previously identified improvement opportunity, the current ticket price may be determined to be lower than the previous purchase price. In some embodiments, a difference in price may be recorded as realized savings and the current ticket price added to the monitor record as the baseline price for future price checks. See FIG. 13.

Otherwise, if the monitor record currently being processed does not match an existing monitor record, then in block 535, routine 500 stores the monitor record to the availability-monitor database (e.g., database 260).

In block 540, routine 500 schedules an invocation of routine 700 (see FIG. 7, discussed below) to monitor the availability of the monitor record. In some embodiments, routine 500 may schedule an immediate invocation of routine 700. In other embodiments, routine 500 may schedule an invocation of routine 700 at some point in the future (e.g., one hour, four hours, 24 hours, or the like). In some embodiments, routine 500 may also set a date and/or time to stop monitoring the monitor record (e.g., at or shortly before the departure date and/or time).

In closing loop block 545, routine 500 iterates back to block 515 to process the next monitor record (if any). Once all monitor records have been processed, routine 500 ends in block 599.

FIG. 6 illustrates a subroutine 600 for extracting one or more monitor records from a given Flight PNR (and associated metadata), such as may be performed by availability-monitoring server 200 in some variants.

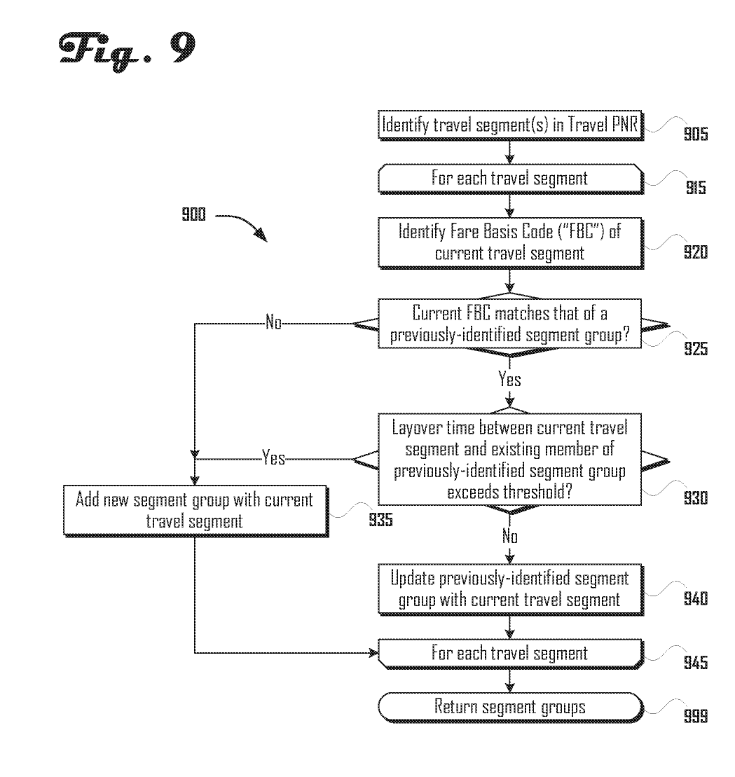

In subroutine block 900, subroutine 600 calls subroutine 900 (see FIG. 9, discussed below) to identify one or more flight tickets in the given flight PNR. For example, if given Flight PNR 405 (see FIG. 4, discussed above), subroutine 600 may identify a first segment group including flight segments 430 and 433 and a second segment group including flight segments 431-32.

In block 610, subroutine 600 identifies one or more passengers in the given flight PNR. For example, if given Flight PNR 405, subroutine 600 may identify passenger 425. Generally, such passenger data is apparent from the PNR data.

In block 615, subroutine 600 identifies a record locator or other identifier identifying the given flight PNR. For example, if given Flight PNR 405, subroutine 600 may identify record locator 415. Generally, such passenger data is apparent from the PNR data.

In block 620, subroutine 600 determines an entity identifier identifying an entity associated with the passenger(s) identified in block 610. Typically, the entity may be a company that employs the passenger(s) and/or that has engaged the flight-availability monitoring service that operates the device performing subroutine 600. In some embodiments, such an entity identifier may be apparent from the PNR data. However, in other embodiments, an entity identifier may be determined based on other metadata associated with the given Flight PNR. For example, in one embodiment, an entity identifier may be determinable based on PNR data such as a PCC or other data identifying a booking agent (e.g., identifier 420) in combination with an identifier identifying the CRS queue into which the given Flight PNR was placed by the booking agent.

More particularly, a CRS may provide several numbered queues (e.g., queue nos. 1-99) into which booking agents can place PNRs to provide those PNRs to an availability-monitoring service. The availability-monitoring service and a given booking agent may agree to use particular queues for PNRs purchased by particular entities. For example, a booking agent may use queue no. 1 for PNRs purchased by Acme, Inc.; queue no. 2 for PNRs purchased by Computer Co.; and so on. A PNR generally includes a PCC or other data identifying a booking agent (e.g., identifier 420), and subroutine 600 may have access to data identifying the queue in which the given Flight PNR was provided. Thus, in such an embodiment, subroutine 600 may consult a lookup table or other data structure to map a booking-agent/queue no. pair to an entity identifier, such as entity identifier 440.

Beginning in opening loop block 625, subroutine 600 processes each flight ticket identified in subroutine block 900. In block 630, subroutine 600 determines the availability of the current flight ticket. Generally, the ticket availability is apparent from the PNR data, as are certain ticket attributes, frequently including the airline and a fare class (e.g., “F” and “P” for first class and first class premium, “C” and “J” for business and business premium, “Y” for economy/coach, and so on).

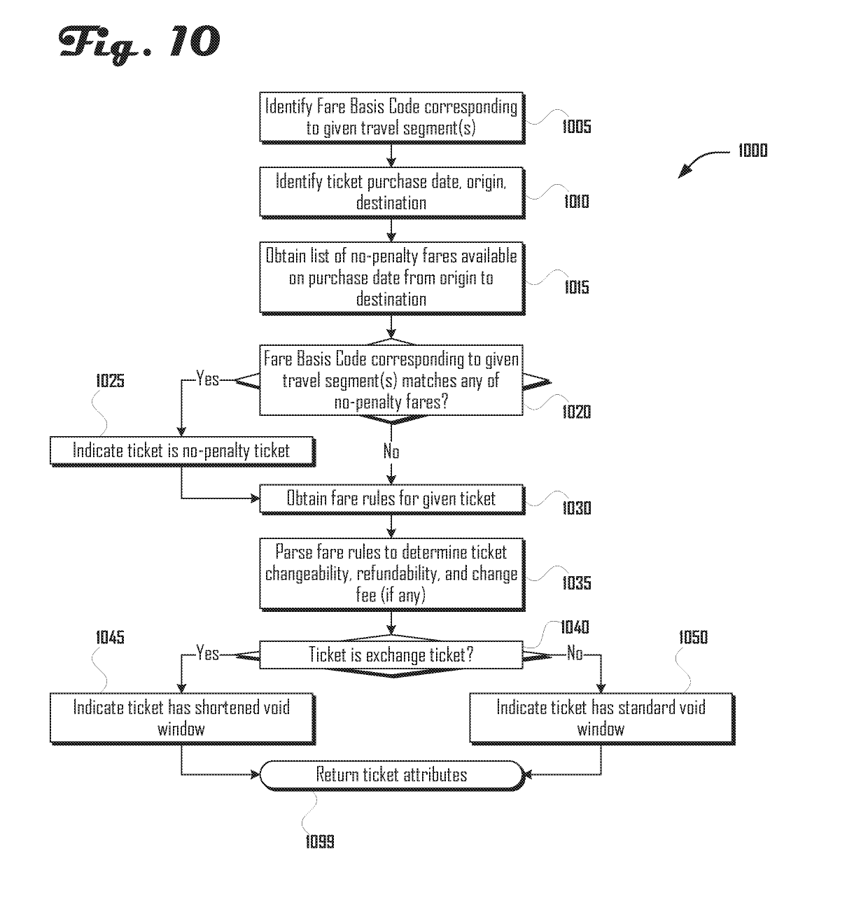

In subroutine block 1000, subroutine 600 calls subroutine 1000 (see FIG. 10, discussed below) to determine additional ticket pricing attributes, such as penalty, changeability, refundability, change fee, and/or void window statuses. In alternate embodiments, instead of or in addition to calling subroutine 1000, subroutine 600 may obtain some or all such ticket attributes by consulting a table including data such as that shown in Table 1, which maps airline/fare-class pairs to ticket attributes such as cabin class and whether the airline imposes a change fee or other penalty for re-ticketing or re-booking the flight.

TABLE 1
Airline/Fare class attribute lookup

| airline_id | fare_class | cabin_class_id | is_penalty |
|---|---|---|---|
| 1 | A | 4 | 1 |
| 1 | B | 1 | 1 |
| 1 | C | 3 | 1 |
| 1 | D | 3 | 1 |
| 1 | E | 1 | 1 |
| 1 | F | 4 | 0 |

In block 640, subroutine 600 initializes a data structure for a monitor record. In some embodiments, such a monitor “record” may comprise one or more records in one or more database tables of an availability-monitor database (e.g., database 260) determined according to accepted database design principles. Nonetheless, for explanatory purposes, such a collection of related records is referred to herein simply as a monitor record.

In block 640, subroutine 600 determines “macro” and “micro” travel-fingerprints characterizing the current flight ticket. As discussed above, PNRs can change for many reasons, and ticket-fingerprints may be useful to distinguish changes that are significant for availability-monitoring purposes (e.g., a change to a different airline, a different arrival and/or departure date, a different passenger, a different origin and/or destination, and the like) from PNR changes that are less significant for availability-monitoring purposes (e.g., a change to a flight number, arrival and/or departure time, and the like) from changes that are insignificant for availability-monitoring purposes (e.g., passenger contact or demographic details, special requests, and the like).

To that end, in one embodiment, a macro travel fingerprint may be sensitive to changes to the passenger's identity, the entity (e.g., employer) associated with the passenger, and some or all of the following data points for each flight segment:
Airline (e.g., Alaska Airlines);
Origination (e.g., Seattle);
Destination (e.g., Orlando);
Departure date (e.g., May 25, 2012); and
Arrival date (e.g., May 25, 2012).

Similarly, in one embodiment, a micro travel-fingerprint may be sensitive to changes to all of the data points included in the macro travel-fingerprint, as well as some or all of the following data points for each flight segment:
Flight number (e.g., 18);
Departure time (e.g., 08:45); and
Arrival time (e.g., 17:14).

In some embodiments, standardized International Air Transport Association (“IATA”) codes may be used to represent appropriate flight-segment data points (e.g., two-digit IATA airline designators may represent the airline and/or three-digit airport codes may represent the points of origination and/or destination).

In some embodiments the passenger's identity may be represented by only the passenger's last name, or the passenger's last name and first initial, because it is not uncommon for a PNR to refer at various times to different version of the passenger's first name (e.g., “Tom” vs. “Thomas”).

In some embodiments the entity's identity may be represented by a code or identifier assigned to the entity by the booking agent and/or the availability-monitoring service (e.g., entity ID “DEF345”).

In various embodiments, the data comprising a macro or micro travel-fingerprint may be stored in various ways. For example, in one embodiment, the data points comprising a travel-fingerprint may be normalized and concatenated to a single string (e.g. “SMITH DEF345 AK SEA MCO 20120525 20120525 AK MCO SEA 20120531 20120531” for an exemplary macro travel-fingerprint) or block of data and encoded into a form that facilitates search, comparison, and/or storage efficiency, such as a message digest or “hash” (e.g., hashes 445A-B, 450A-B). In various embodiments, a hash may be computed using any suitable cryptographic hash function, such as MD5, MD6, SHA-0, SHA-1 SHA-2, SHA-3, or the like.

In other embodiments, a travel-fingerprint may be represented by literal data structures, such as a concatenated string (e.g. “SMITH DEF345 AK SEA MCO 20120525 20120525 AK MCO SEA 20120531 20120531” for an exemplary macro travel-fingerprint) or a series of structured data fields or key/value pairs (e.g., {“Name”:“SMITH”, “Entity”:“DEF345”, “Airline”:“AK” . . . }).

In block 655, the monitor record is populated at least in part with data collected in blocks 900, 610, 615, 620, 630, 1000, and 650. In closing loop block 660, subroutine 600 iterates back to block 625 to process the next flight ticket (if any). Once all flight segment groups have been processed, subroutine 600 ends in block 699, returning the monitor record(s) to the caller.

FIG. 7 illustrates a routine 700 for monitoring the availability of a given monitor record, such as may be performed by availability-monitoring server 200 in some variants. In various embodiments, routine 700 may be invoked for a given monitor record according to a fixed or variable periodic schedule.

In block 701, routine 700 obtains from an availability-monitor database (e.g., database 260) the given monitor record, representing the flight ticket whose availability is to be monitored. In block 705, routine 700 identifies the PNR corresponding to the given monitor record (e.g., by retrieving the PNR's Record Locator from the monitor record).

In block 710, routine 700 requests and obtains the up-to-date or “master” version of the Flight PNR from a computerized reservation system (e.g., the system that operates CRS device 105).

Having obtained the up-to-date Flight PNR, in block 715, routine 700 identifies up-to-date macro and micro travel-fingerprints based on data extracted from the up-to-date Flight PNR. For example, in one embodiment, routine 700 may employ a process similar to that shown in FIG. 6 and described above to obtain the up-to-date macro and micro travel-fingerprints.

In decision block 720, routine 700 determines whether the up-to-date macro travel-fingerprint matches the macro travel-fingerprint associated with the given monitor record. If the macro travel-fingerprints do not match, then a significant change has occurred to the Flight PNR since the given monitor record was extracted, and routine 700 will cease to monitor the given monitor record. Rather, in subroutine block 600, routine 700 extracts an up-to-date monitor record from the up-to-date Flight PNR and proceeds to subroutine block 800 (discussed below) to continue processing the new up-to-date monitor record.

On the other hand, if in decision block 720, routine 700 determines that the macro travel-fingerprints do match, then the up-to-date Flight PNR has not significantly changed for availability-monitoring purposes since the given monitor record was extracted, and in decision block 730, routine 700 determines whether the up-to-date micro travel-fingerprint matches the micro travel-fingerprint associated with the given monitor record. If the micro travel-fingerprints do not match, then a detail change has occurred to the Flight PNR since the given monitor record was extracted, and in block 735, routine 700 updates the given monitor record to match the details represented in the up-to-date Flight PNR.

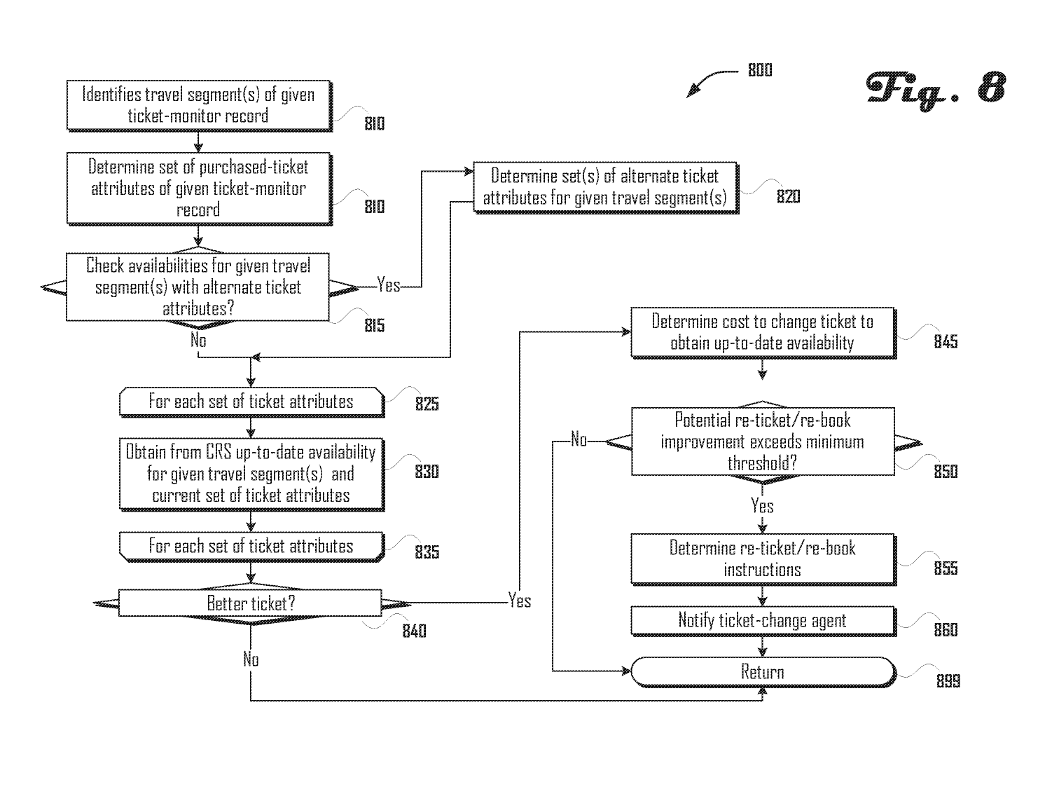

Once the given monitor record matches all macro and micro fingerprint attributes of the up-to-date Flight PNR, then in subroutine block 800 (see FIG. 8, discussed below), routine 700 checks up-to-date pricing for the flight segment(s) represented in the monitor record.

In decision block 740, routine 700 determines whether to continue availability-monitoring the monitor record. For example, in some embodiments, the schedule may have a pre-determined end point past which the monitor record need not be monitored. In other embodiments, routine 700 may dynamically determine whether future favorable availability changes are unlikely (e.g., because the departure time is imminent) to determine whether to continue availability-monitoring the monitor record. If routine 700 determines not to continue monitoring the monitor record, then routine 700 ends in block 799.

On the other hand, if routine 700 determines to continue monitoring the monitor record, then in block 745, routine 700 determines a next date and/or time to check the availability for the monitor record. In some embodiments, routine 700 may simply determine to schedule the next availability-check on a fixed schedule or after a fixed period of time (e.g., after 4, 6, 8, or 24 hours, or another period of time). In such fixed-schedule embodiments, the availability-checks for a given monitor record may be determined in advance and pre-scheduled using job scheduler and/or workload automation software, such as cron, launchd, Windows Task Scheduler, or other like utility.

In other embodiments, routine 700 may determine a dynamic schedule based on expected volatility (in price or other terms, e.g.). For example, in one embodiment, flight prices may generally be the most volatile during a period between 7-30 days prior to departure, and consequently, routine 700 may schedule availability checks more frequently (e.g., every four hours) during periods of expected high volatility and less frequently (e.g., once per day) during periods of expected low volatility. Computerized reservation systems typically charge a small fee (on the order of a few pennies) for obtaining current ticket prices, so routine 700 may dynamically adjust the schedule to minimize incurring costs that are unlikely to lead to cost savings or other improvements.

In block 750, routine 700 schedules an availability-check for the monitor record at the next date and/or time determined in block 745 (although, as discussed above, in some fixed-schedule embodiments, the availability-checks for a given monitor record may be determined in advance and pre-scheduled using job scheduler and/or workload automation software). Routine 700 ends in block 799.

FIG. 8 illustrates a subroutine 800 for checking up-to-date pricing for flight segment(s) represented in a given monitor record, such as may be performed by availability-monitoring server 200 in some variants. In block 805, subroutine 800 identifies one or more flight segments represented by the given monitor record. For example, if given monitor record 410A, subroutine 800 may identify flight segments 430 and 433.

In block 810, subroutine 800 determines a set of one or more purchased-ticket attributes associated with the flight ticket represented by the given monitor record (e.g., ticket 435). (See, e.g., fare-class ticket-attributes discussed in respect of FIG. 6, above, and FIG. 10, below.)

In decision block 815, subroutine 800 determines whether to check up-to-date prices for tickets having alternate attributes for the given flight segment(s). If so, then in block 820, subroutine 800 determines a set of one or more alternate ticket attributes that would be acceptable substitutes for the purchased-ticket in the current context.

For example, in one embodiment, if the purchased ticket is in a business-class fare class, subroutine 800 would not determine to check prices for economy-class tickets because an economy-class ticket is not an acceptable substitute for a business class ticket. For another example, if the purchased ticket is unrestricted (e.g., no Saturday night stay is required), subroutine 800 would not determine to check prices for restricted tickets (e.g., those that require a Saturday night stay).

On the other hand, in some contexts, subroutine 800 may determine that alternate ticket attributes would be acceptable substitutes for the purchased ticket. For example, in some cases, the purchased ticket was purchased far in advance and has attributes that it is fully refundable and/or has no “change” penalty (e.g., does not require an additional fee to re-book). However, if it is currently only a few days prior to departure, subroutine 800 may determine that an otherwise identical ticket that is nonrefundable and/or that has a change penalty would be an acceptable substitute (as the travel is unlikely to be canceled or changed so close to the departure). In some embodiments, the threshold within which a change-penalty ticket would be considered an acceptable substitute for a no-change-penalty ticket may be specified by the entity that engaged the availability-monitoring service.

Beginning in opening loop block 825, subroutine 800 iterates over each set of acceptable ticket attributes that it has determined to availability-check (the purchased-ticket attributes set determined in block 810 and any alternate attribute sets that were determined in block 820).

In block 830, subroutine 800 requests and obtains an up-to-date availability for the given flight segment(s) and the current set of ticket attributes from a computerized reservation system (e.g., the system that operates CRS device 105).

In closing loop block 835, subroutine 800 iterates back to block 825 to process the next set of acceptable ticket-attributes (if any).

In block 840, subroutine 800 determines whether it obtained an up-to-date price for a ticket with acceptable ticket attributes that is lower than the purchased-price for the given monitor record. If not, then routine 800 ends in block 899.

On the other hand, if subroutine 800 obtained an up-to-date for an identical or acceptable-substitute flight ticket, then in block 845, subroutine 800 determines how much it would cost to re-book the flight ticket to obtain the up-to-date (lower) pricing. In some embodiments, subroutine 800 may obtain re-ticket/re-book costs by consulting previously identified ticket attributes (see FIG. 10, discussed below). In alternate embodiments, subroutine 800 may obtain re-ticket/re-book costs by consulting a table including data such as that shown in Table 2, which maps ticket-change fees and ticket-cancel fees by airline, region or origin, and region of destination. For example, according to Table 2, for an American Airlines flight within the northeast region of the United States, the cost to change or cancel a ticket is $275.

TABLE 2
Change and Cancel fees by airline and region

| airline- | origin- | destination- | change- | cancel- | cancel- |
|---|---|---|---|---|---|
| code | region | region | fee | window | fee |
| AA | US- | US-NE | $275 | 0 | $2 |
| | NE | | | | 75 |
| UA | US- | US-NE | $250 | 0 | $2 |
| | NE | | | | 50 |
| DL | US- | US-NE | $250 | 0 | $2 |
| | NE | | | | 50 |
| B6 | US- | US-NE | $0 | 0 | $0 |
| | NE | | | | |
| US | US- | US-NE | $250 | 0 | $2 |
| | NE | | | | 50 |

Using such ticket-change fee and ticket-cancel fee data, subroutine 800 can determine the cost to re-book the flight ticket to obtain the up-to-date (lower) pricing. In decision block 850, subroutine 800 determines whether the potential improvements exceeds a predetermined threshold for the entity associated with the flight ticket. For example, if the up-to-date price for a given ticket is $500, the purchased price is $800, and the change/cancel fee is $275, then the potential improvements is only $25 ($800 less the sum of $500 and $275). If the entity associated with the flight ticket (e.g., the employer of the passenger) has specified that it only wishes to capture improvements that exceed $100 (or an equivalent improvement value expressed in “points,” e.g.), then subroutine 800 would determine that the potential improvements do not exceed the minimum threshold, and routine 800 would end in block 899.

Conversely, if the up-to-date availability for a given ticket is $500, the purchased price is $1000, and the change/cancel fee is $275, then the potential improvements is $225, and subroutine 800 may determine to proceed to block 855 to determine re-ticket/re-book instructions for capturing the improvement that has been identified. For example, in one embodiment, subroutine 800 may assemble an instruction string instructing a travel agent to cancel the purchased ticket and purchase a specific new ticket at the up-to-date price or to change the purchased ticket to the specific new ticket.

In block 860, subroutine 800 notifies an agent of the potential improvements. For example, in one embodiment, subroutine 800 may insert the instruction string determined in block 855 into a remarks field of the Flight PNR associated with the given monitor record, and submit the altered Flight PNR into a CRS queue provided by the computer reservation system and monitored by a travel agent who can act on the instructions. In some embodiments, subroutine 800 may select among two or more prioritized queues, depending on the urgency and/or importance of the identified potential improvements. In other embodiments, subroutine 800 may encode an “urgency” attribute into the Flight PNR before placing it into a CRS queue, such that a travel agent may be able to query the CRS queue according to “urgency” attributes to identify prioritized Flight PNRs. In other embodiments, subroutine 800 may alert a travel agent of the potential improvements (and instructions) via another communication channel, such as an email, instant message, or other like channel.

In alternate embodiments, subroutine 800 may call a re-ticket/re-book routine (not shown) to automatically capture the potential improvements if the circumstances warrant, having identified potential improvements and instructed a ticket-change agent on how to capture the potential improvements, subroutine 800 ends in block 899.

FIG. 9 illustrates a subroutine 900 for identifying flight segment group(s) in a given Flight PNR, such as may be performed by an availability-monitoring server 200 in some variants.

In block 905, subroutine 900 identifies one or more flight segments in the given Flight PNR. For example, if given Flight PNR 405 (see FIG. 4, discussed above), subroutine 900 may identify flight segments 430-33.

Beginning in opening loop block 915, subroutine 900 processes each flight segment in turn. In block 920, subroutine 900 identifies a fare basis code corresponding to the current flight segment. For example, when processing flight segment 430 or 433 of 410A monitor record, subroutine 900 may identify the fare basis code “CS FASR”, whereas when processing flight segment 431-32 of 410B monitor record, subroutine 900 may identify the fare basis code “SA07ERD1”. Generally speaking, such fare basis codes may encode meaning that may be understood by a travel agent and/or a specific air carrier. However, in some embodiments, fare basis codes may be treated by subroutine 900 simply as strings that may be compared to one another without regard to their encoded meanings.

In decision block 925, subroutine 900 determines whether the fare basis code of the current flight segment matches a fare basis code associated with any flight segment group that may have been identified in a previous iteration. If so, then subroutine 900 proceeds to decision block 930. Otherwise, subroutine 900 proceeds to block 935.

In decision block 930, subroutine 900 determines whether there is a layover (i.e., time spent at a terminal after departing one plane and waiting to board the next) between the current flight segment and any flight segment that is a member of the flight segment group matched in decision block 925, and if there is such a layover, whether the time spent waiting to board the next flight exceeds a predetermined threshold (e.g., 8 to 12 hours).

If so, then subroutine 900 proceeds to block 935 as when a layover exceeding such a threshold exists, then the current flight segment may not belong to the flight segment group matched in decision block 925, notwithstanding the identical fare basis codes. Otherwise, subroutine 900 proceeds to block 940.

In block 935, subroutine 900 creates a new segment group including the current flight segment. In block 940, subroutine 900 updates the flight segment group matched in decision block 925 such that it includes the current flight segment.

In ending loop block 945, subroutine 900 iterates back to opening loop block 915 to process the next flight segment, if any. Once all flight segments have been processed, subroutine 900 ends in ending block 999, returning the identified flight segment group(s) to the caller.

FIG. 10 illustrates a subroutine 1000 for determining ticket pricing attributes corresponding to a given flight segment group, such as may be performed by an availability-monitoring server 200 in some variants.

In block 1005, subroutine 1000 identifies a fare basis code corresponding to the given flight segment group. For example, when processing flight segment 430 or 433 of 410A monitor record, subroutine 1000 may identify the fare basis code “CS FASR”, whereas when processing flight segment 431-32 of 410B monitor record, subroutine 1000 may identify the fare basis code “SA07ERD1”. Generally speaking, such fare basis codes may encode meaning that may be understood by a travel agent and/or a specific air carrier. However, in some embodiments, fare basis codes may be treated by subroutine 1000 simply as strings that may be compared to one another without regard to their encoded meanings.

In block 1010, subroutine 1000 identifies basic ticket attributes corresponding to the given flight segment group, including a ticket purchase date, a flight origin, and a flight destination.

In block 1015, subroutine 1000 obtains from a CRS a list of no-penalty fares that were available on the ticket purchase date between the flight origin and the flight destination as determined in block 1010.

In decision block 1020, subroutine 1000 determines whether the fare basis code identified in block 1005 matches a fare basis code associated with any of the no-penalty fares (as obtained in block 1015).

If so, then subroutine 1000 proceeds to block 1025. Otherwise, subroutine 1000 proceeds to block 1030.

In block 1025, subroutine 1000 stores an indication that the ticket corresponding to the given flight segment group is a no-penalty ticket.

In block 1030, subroutine 1000 obtains (e.g., from a CRS) one or more fare rules corresponding to the ticket. In some embodiments, the fare rules thereby obtained may take the form of a block of human-readable (if jargon-filled) text.

In block 1035, subroutine 1000 parses the fare rules (as obtained in block 1030) to determine such ticket attributes as whether the ticket is changeable or non-changeable, and if it is changeable, then what the change fee (if any) would be for changing to a different fare, and whether a change to a lower fare would result in a refund or a credit (in which case, the ticket would be considered to be refundable), or a forfeit of the difference between the original fare and the changed lower fare. In some embodiments, a natural language processing toolkit may be employed to parse the fare rules.

In decision block 1040, subroutine 1000 determines whether the ticket corresponding to the given flight segment group is an exchange ticket (e.g., whether the ticket in question was previously re-booked or re-ticketed). In some embodiments, a coupon status attribute of the ticket may be consulted when determining whether the ticket is an exchange ticket.

If so, then subroutine 1000 proceeds to block 1045. Otherwise, subroutine 1000 proceeds to block 1050.

In block 1045, subroutine 1000 stores an indication that the ticket has a shortened void window (the period of time during which the ticket may be canceled without penalty). For example, in the Sabre Global Distribution System in North America, in the case of an exchange ticket, the shortened void window typically expires at 23:59CST the same day as the ticket was purchased. Other CRS/GDS systems and/or other regions may have different shortened void windows.

In block 1050, subroutine 1000 stores an indication that the ticket has a standard void window. For example, in the Sabre Global Distribution System in North America, the standard void window typically expires at 23:59CST the day after the ticket was purchased. Other CRS/GDS systems and/or other regions may have different standard void windows.

In ending block 1099, subroutine 1000 returns the determined ticket attributes to the caller.

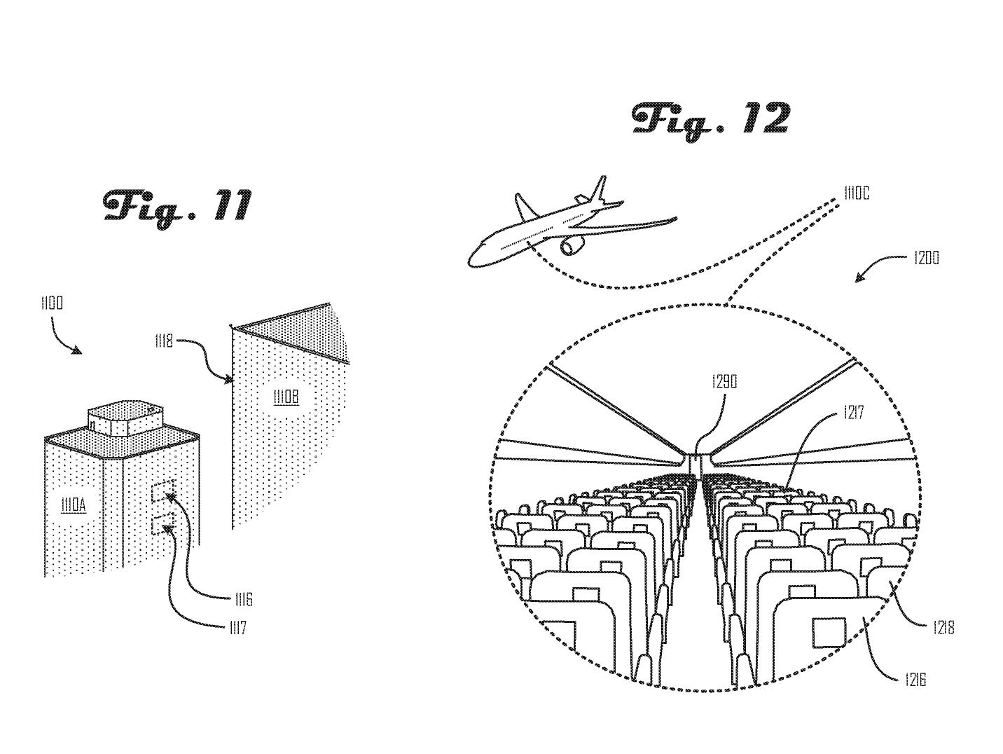

FIG. 11 illustrates a physical context 1100 of one or more stationary facilities 1110A-B each having a space 1116, 1117, 1118 suitable for occupation by one or more parties (guests or other travelers, e.g.) as further described below.

FIG. 12 illustrates a physical context 1200 of one or more mobile facilities 1110C (passenger airplanes or other powered vehicles, e.g.) each having one or more spaces 1216, 1217, 1218 suitable for occupation by one or more parties (guests or other travelers, e.g.) as further described below. It will be understood that “mobile” and “stationary” facilities are considered mutually exclusive for present purposes. For at least this reason a mobile space is not a “suitable” substitute for a stationary space as described herein, nor vice versa. As shown one of the spaces 1217 is substantially closer to an amenity 1290 (an exit, e.g.) than the other spaces 1216, 1218. In some variants such a position is “better” than the others by a “difference” expressible in meters, as further described below.

FIG. 13 illustrates an event-sequencing structure comprising special-purpose transistor-based circuitry 1300—optionally implemented as an Application-Specific Integrated Circuit (ASIC), e.g.—in which some or all of the functional modules described below may be implemented. Transistor-based circuitry 1300 is an event-sequencing structure generally as described in U.S. Pat. Pub. No. 20150094046 but configured as described herein. Transistor-based circuitry 1300 includes one or more instances of retrieval modules 1321, for example, each including an electrical node set 1331 upon which informational data is represented digitally as a corresponding voltage configuration 1341.

In the interest of concision and according to standard usage in information management technologies, the functional attributes of modules described herein are set forth in natural language expressions. It will be understood by those skilled in the art that such expressions (functions or acts recited in English, e.g.) adequately describe structures identified below so that no undue experimentation will be required for their implementation. For example, any records or other informational data identified herein may easily be represented digitally as a voltage configuration on one or more electrical nodes (conductive pads of an integrated circuit, e.g.) of an event-sequencing structure without any undue experimentation. Each electrical node is highly conductive, having a corresponding nominal voltage level that is spatially uniform generally throughout the node (within a device or local system as described herein, e.g.) at relevant times (at clock transitions, e.g.). Such nodes (lines on an integrated circuit or circuit board, e.g.) may each comprise a forked or other signal path adjacent one or more transistors. Moreover many Boolean values (yes-or-no decisions, e.g.) may each be manifested as either a “low” or “high” voltage, for example, according to a complementary metal-oxide-semiconductor (CMOS), emitter-coupled logic (ECL), or other common semiconductor configuration protocol. In some contexts, for example, one skilled in the art will recognize an “electrical node set” as used herein in reference to one or more electrically conductive nodes upon which a voltage configuration (of one voltage at each node, for example, with each voltage characterized as either high or low) manifests a yes/no decision or other digital data.

Transistor-based circuitry 1300 further includes one or more instances of implementation modules 1322 each including an electrical node set 1332 upon which informational data is represented digitally as a corresponding voltage configuration 1342 as shown. Transistor-based circuitry 1300 further includes one or more instances of response modules 1323 each including an electrical node set 1333 upon which informational data is represented digitally as a corresponding voltage configuration 1343 as shown. Transistor-based circuitry 1300 may further manifest one or more policy changes including an older policy 1375A (under which one or more instances of an order 1355 that includes a space identifier 1362 was previously established, e.g.) and a proposed or other newer policy 1375B (under which space identifier 1361 is identified as more preferable than the previously established space identifier 1362, e.g.). This can occur, for example, in a context in which one or more criteria 1367 under which the prior order 1355 was placed have changed or are proposed to change in an effort to manifest a quantifiable improvement (quantified by one or more differences 136 each corresponding to a particular “superior” space, e.g.) as further described below. In some contexts, moreover, itinerary datasets (or allocation-indicative portions of them) may reside in (an instance of) server 200 located at the respective facilities 1110A-C to ensure the allocation of spaces thereof is appropriately manifested. In some variants, “allocation” as used herein refers to performing an order or reservation or booking.

As used herein, a “policy” refers to a ruleset by which possibly-suitable spaces are given an evaluation or other preferability-indicative quantification such that at least one of the spaces is indicated as better than another. For example such quantifications may be expressed in miles (to a destination, e.g.), linear inches or square inches (of an airplane seat, e.g.) or square feet (of a hotel room, e.g.), points (on a 1-to-10 quality scale or as a percentage, e.g.), currency, or other such preferability-indicative units. A “policy change” as used herein may include one or more spaces becoming eligible (by virtue of a cancellation or promotion, e.g.), an amenity (being adjacent to a window or having an ocean view, e.g.) newly receiving a non-zero valuation (a meal included gratis with the space having previously been valued at zero now counting as 3 points, e.g.), a promotional discount that affects future purchases (but not booked purchases) provided by a given vendor, or almost any other event by which comparable spaces might become relatively “superior” and “inferior” to one another (manifesting one or more newly-encoded user/traveler/institutional preferences, e.g.).

FIG. 14 illustrates a method 1400 (a routine executable by transistor-based circuitry 1300, e.g.) for responding to a policy change or discovery of a substitutable physical space (or both), such as may be performed by one or more monitoring servers 200 in some variants. As shown, method 1400 includes device-executable operations 1430, 1440, 1450 as described below.

Operation 1430 depicts obtaining an itinerary dataset that includes an allocation of an initial space to a first party (retrieval module 1321 initially obtaining a booking of a lodging space 1116 to passenger Smith, e.g.). This can occur, for example, in a context in which (an instance of) electrical node set 1331 contains a voltage configuration 1341 that manifests the itinerary dataset. In some variants, for example, voltage configuration 1341 may express a room number of a lodging space 1116 with a parking lot view or a twin bed (or both). This can occur, for example, in a context in which the initial booking did not take any such features into account, having been selected with a prior policy 1375A that used price alone.

Operation 1440 depicts implementing a policy change by which one or more available substitute spaces are compared to the initial space and by which the initial space is determined to be inferior and by which one of the one or more available substitute spaces is determined to be superior (implementation module 1322 computing evaluations that quantitatively establish that space 1117 is more preferable than space 1116 in light of an actual or potential adoption of policy 1375B in lieu of policy 1375A, e.g.). This can occur, for example, in a context in which (an instance of) electrical node set 1332 contains a voltage configuration 1342 that manifests one or more space identifiers 1361 identifying one or more superior spaces 1117, in which policy 1375B takes into account a bigger bed in space 1117 and in which a quantified difference 1368 is enough so that that amenity alone is sufficient to make space 1117 “superior” (exceeding a threshold notwithstanding that space 1117 has essentially the same parking lot view, e.g.).

Operation 1450 depicts automatically responding to a discovery of the availability of the superior space by conditionally allocating the superior space to the first party as a real-time response partly based on the policy change being applied to the itinerary dataset that includes the allocation of the inferior space to the first party and partly based on the discovery of the availability of the superior space determined by the policy change (response module 1323 automatically responding to a discovery of the availability of the superior space 1117 by conditionally allocating the superior space to passenger Smith in real time partly based on response module 1323 determining that the “superior” space 1117 is better than “inferior” space 1116 by a net difference 1368, e.g.). This can occur, for example, in a context in which circuitry 1300 includes a comparator (not shown), in which difference 1368 is evaluated as 50 square feet (exceeding a threshold of 25 square feet, e.g.) or as 15 points (exceeding a threshold of 5 points, e.g.), in which the threshold is manifested as a voltage configuration 1343 on electrical node set 1333 provided as an input to the comparator, and in which no human could otherwise notice and respond to a just-issued policy 1375B (in which bed size is given a significant weight by an employer of passenger Smith, e.g.) in time to grab space 1117 (before space 1117 gets booked for a different guest instead, e.g.).

In another scenario illustrating the operation of method 1400, operation 1430 is performed by a transistor-based module receiving the itinerary dataset well in advance of the policy change and operation 1440 includes receiving a notification of (1) a policy change that facility 1110B is now becoming a participating service provider and (2) an availability of a favored space 1118 (having an ocean view, e.g.) on dates for which passenger Smith has previously booked his lodging at facility 1110A instead. If the net difference 1368 of this change is large enough so that response module 1323 deems space 1118 “superior” on that basis, operation 1430 may perform operation 1450 by booking space 1118 (or by suggesting such a booking to his travel agent, e.g.) immediately on behalf of passenger Smith.

In another scenario illustrating the operation of method 1400, operation 1430 is performed by retrieval module 1321 obtaining an itinerary dataset that includes an allocation of an aisle seat as the “initial” space 1216. Operation 1440 is performed by (an instance of) implementation module 1322 identifying a plurality of spaces 1217, 1218 each “superior” to the initial space (to the traveler or travel agent designated to receive and decide between such time-sensitive options, e.g.). This can occur, for example, in a context in which one of the alternative spaces 1217 is “superior” for one reason (having a scalar score with units of distance to an amenity 1290, e.g.) and in which another of the spaces 1218 is “superior” for another reason (having a scalar score affected by a manifest preference for being less expensive, e.g.). Operation 1450 is performed by response module 1323 automatically offering the “first” party a choice between the two highest-ranking “superior” spaces (whether or not there are others, e.g.) as a real-time response at least partly based on them being discovered contemporaneously in the wake of the policy change. Such a simple question, for example, allows an implementation in which the recipient of the offer can select between them by selecting “1” or “2” during a telephonically implemented menu (pressing or speaking these responses during a robo-call, e.g.).

In light of teachings herein, numerous existing techniques may be applied for configuring special-purpose circuitry or other structures effective for quantifying factors that affect preferences as described herein without undue experimentation. See, e.g., U.S. Pat. No. 9,217,648 (“Method of operating a navigation system to provide a pedestrian route”); U.S. Pat. No. 9,178,994 (“Methods for providing self-support services using information from a viral source”); U.S. Pat. No. 8,874,489 (“Short-term residential spaces in a geo-spatial environment”); U.S. Pat. No. 8,798,899 (“System and method for controlling operation of an airline”); U.S. Pat. No. 8,781,912 (“Computer-based method and computer program product for setting floor prices for items sold at auction”); U.S. Pat. No. 8,732,018 (“Real-time offers and dynamic price adjustments presented to mobile devices”); U.S. Pat. No. 8,706,564 (“Methods for dynamic discounting”); U.S. Pat. No. 8,700,481 (“Conditional purchase offer management system”); U.S. Pat. No. 8,595,039 (“Multi-passenger multi-route travel planning”); and U.S. Pat. No. 8,571,903 (“Pricing graph representation for sets of pricing solutions for travel planning system”).

With respect to the numbered claims expressed below, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

What is claimed is:

1. A real-time server-implemented space availability response method, the method comprising:
obtaining from a mobile travel-agent device a request to monitor upgrade availability associated with a previously-booked travel itinerary;
obtaining from a computerized reservation system (CRS) an itinerary record corresponding to said previously-booked travel itinerary;
identifying a plurality of travel segments indicated by said itinerary record as a component of obtaining an itinerary dataset that includes an allocation of an initial space to a first party, wherein the previously-booked travel itinerary manifests the itinerary dataset and wherein one of the plurality of travel segments determines the initial space allocated to the first party;
grouping one or more of said plurality of travel segments into a travel-segment group for which a travel ticket was previously purchased as a component of implementing a policy change by which one or more available substitute spaces are compared to the initial space and by which the initial space is determined to be inferior and by which one of the one or more available substitute spaces is determined to be superior, wherein the previously-purchased travel ticket defines the allocation of the inferior space to the first party, and wherein the superior and inferior spaces are airplane seats;
determining, based at least in part on said itinerary record, segment-group-associated metadata associated with said travel-segment group, said segment-group-associated metadata including a surname of the first party and a purchase date;
generating a macro ticket fingerprint based at least in part on macro metadata including said surname, and segment-associated metadata associated with each travel segment of said travel-segment group, said segment-associated metadata including a plurality of data items selected from an airline identifier, a travel origin identifier, a travel destination identifier, a departure date, and an arrival date;
inserting or updating a ticket-monitor record, identified according to said macro ticket fingerprint, in a data store such that said ticket-monitor record comprises said segment-associated metadata, said segment-group-associated metadata, and said macro ticket fingerprint; and
automatically responding to a discovery of said availability of said superior space by conditionally signaling an allocation of the superior space to said first party as a real-time response partly based on said policy change being applied to the itinerary dataset that includes the allocation of the inferior space to the first party and partly based on said discovery of said availability of said superior space determined by the policy change.

2. The real-time server-implemented space availability response method of claim 1, wherein the implementing the policy change by which the one or more available substitute spaces are compared to the initial space and by which the initial space is determined to be inferior and by which one of the one or more available substitute spaces is determined to be superior comprises:
determining an availability-monitoring schedule based at least in part on said segment-associated metadata.

3. The real-time server-implemented space availability response method of claim 1, wherein the implementing the policy change by which the one or more available substitute spaces are compared to the initial space and by which the initial space is determined to be inferior and by which one of the one or more available substitute spaces is determined to be superior comprises:
determining an availability-monitoring schedule based at least in part on said segment-associated metadata;
obtaining an up-to-date version of said itinerary record from said CRS;
generating an up-to-date macro ticket fingerprint according to metadata extracted from said up-to-date version of said itinerary record;
verifying, according to said macro ticket fingerprint of said ticket-monitor record and said up-to-date macro ticket fingerprint, that since said ticket-monitor record was inserted or updated, no significant change has occurred to said previously-purchased travel ticket;
obtaining current pricing data associated with said previously-purchased travel ticket according to said segment-associated metadata of said ticket-monitor record; and
transmitting an automatic real-time notification to the travel-agent device conditionally, based at least in part on said discovery of said availability of said superior space determined by the policy change by re-ticketing or re-booking at least one of said plurality of travel segments as the allocation of the superior space to said first party.

4. A real-time server-implemented space availability response method, the method comprising:
obtaining an itinerary dataset that includes an allocation of an initial space to a first party;
implementing a policy change by which one or more available substitute spaces are compared to the initial space and by which one of the one or more available substitute spaces is determined to be superior by which the initial space is determined to be inferior; and
automatically responding to a discovery of said availability of said superior space by conditionally signaling an allocation of the superior space to said first party as a real-time response partly based on said policy change being applied to the itinerary dataset that includes the allocation of the inferior space to the first party and partly based on said discovery of said availability of said superior space determined by the policy change.

5. The real-time server-implemented space availability response method of claim 4, wherein the obtaining the itinerary dataset that includes the allocation of the initial space to the first party comprises:
renting a portion of a building to the first party as the allocation of the initial space to the first party.

6. The real-time server-implemented space availability response method of claim 4, wherein the obtaining the itinerary dataset that includes the allocation of the initial space to the first party comprises:
obtaining from a mobile travel-agent device a request to monitor upgrade availability associated with a previously-booked travel itinerary, wherein the previously-booked travel itinerary manifests the itinerary dataset.

7. The real-time server-implemented space availability response method of claim 4, wherein the obtaining the itinerary dataset that includes the allocation of the initial space to the first party comprises:
obtaining from a computerized reservation system (CRS) an itinerary record corresponding to said travel itinerary, wherein the itinerary dataset includes the itinerary record; and
identifying a plurality of travel segments indicated by said itinerary record.

8. The real-time server-implemented space availability response method of claim 4, wherein the obtaining the itinerary dataset that includes the allocation of the initial space to the first party comprises:
identifying a plurality of travel segments indicated by said itinerary dataset, wherein one of the plurality travel segments determines the allocation of the initial space to the first party; and
grouping one or more of said plurality of travel segments into a travel-segment group for which a travel ticket was previously purchased.

9. The real-time server-implemented space availability response method of claim 4, wherein the obtaining the itinerary dataset that includes the allocation of the initial space to the first party comprises:
identifying a plurality of usage dates indicated by said itinerary dataset, wherein one of the usage dates determines the allocation of the initial space to the first party.

10. The real-time server-implemented space availability response method of claim 4, further comprising:
obtaining, via a travel-agent device, a request to monitor upgrade availability associated with a previously-booked travel itinerary;
obtaining, from a computerized reservation system (CRS), an itinerary record corresponding to said travel itinerary;
identifying a plurality of travel segments indicated by said itinerary record;
grouping one or more of said plurality of travel segments into a travel-segment group for which a travel ticket was previously purchased, wherein the previously-purchased travel ticket defines the allocation of the inferior space to the first party and wherein the superior and inferior spaces are both airplane seats;
determining, based at least in part on said itinerary record, segment-group-associated metadata associated with said travel-segment group, said segment-group-associated metadata including the surname of the first party and a purchase date, and an entity identifier identifying an entity on whose behalf said previously-purchased travel ticket was purchased;
generating a macro ticket fingerprint based at least in part on macro metadata including said passenger surname;
inserting or updating a ticket-monitor record, identified according to said macro ticket fingerprint, in a data store such that said ticket-monitor record comprises said segment-associated metadata, said segment-group-associated metadata, and said macro ticket fingerprint;
determining an availability-monitoring schedule based at least in part on said segment-associated metadata; and
periodically monitoring availability associated with the previously-purchased travel ticket.
